(19) United States
(12) Patent Application Publication
(10) Pub. No.: US 2021/0248718 A1
(43) Pub. Date: Aug. 12, 2021

(54) IMAGE PROCESSING METHOD AND APPARATUS, ELECTRONIC DEVICE AND STORAGE MEDIUM

(71) Applicant: SHENZHEN SENSETIME TECHNOLOGY CO., LTD., Shenzhen (CN)

(72) Inventors: Weijiang YU, Shenzhen (CN); Zhe HUANG, Shenzhen (CN); Litong FENG, Shenzhen (CN); Wei ZHANG, Shenzhen (CN)

(21) Appl. No.: 17/241,625

(22) Filed: Apr. 27, 2021

Related U.S. Application Data
(63) Continuation of application No. PCT/CN2019/105628, filed on Sep. 12, 2019.

(30) Foreign Application Priority Data
Aug. 30, 2019 (CN) 201910818055.6

(51) Int. Cl. G06T 5/00; G06T 5/20

(52) U.S. Cl. CPC G06T 5/002; G06T 5/20; G06T 5/005

(57) ABSTRACT

An image processing method includes: performing a progressive removal processing of raindrops with different granularities on an image with raindrops, to obtain an image subjected to the removal processing of raindrops, wherein the progressive removal processing of raindrops with different granularities comprises at least: a first granularity processing and a second granularity processing; and performing fusion processing on the image subjected to the removal processing of raindrops and a to-be-processed image obtained according to the first granularity processing, to obtain a raindrop-removed target image.

### CROSS-REFERENCE TO RELATED APPLICATIONS

This application is a continuation of International Application No. PCT/CN2019/105628, filed on Sep. 12, 2019, which claims priority to Chinese Patent Application No. 201910818055.6, filed on Aug. 30, 2019. The disclosures of International Application No. PCT/CN2019/105628 and Chinese Patent Application No. 201910818055.6 are hereby incorporated by reference in their entireties.

### BACKGROUND

As an important part of artificial intelligence, computer vision technology has increasingly benefited and facilitated human's daily life. Among them, a technique of removing raindrops with high quality from an image with raindrops is receiving more and more attention and application. In daily life, there are many scenarios in which a raindrop removal operation needs to be performed, and a requirement to be achieved is to obtain high-quality scenario information to assist in performing more intelligent tasks.

### SUMMARY

The disclosure relates to the technical field of computer vision, and in particular to an image processing method and image processing apparatus, an electronic device, and a storage medium.

The disclosure provides a technical solution for processing images.

According to an aspect of the disclosure, there is provided an image processing method, including the following operations. A progressive removal processing of raindrops with different granularities is performed on an image with raindrops, to obtain an image subjected to the removal processing of raindrops, herein the progressive removal processing of raindrops with different granularities includes at least: a first granularity processing and a second granularity processing. Fusion processing is performed on the image subjected to the removal processing of raindrops and a to-be-processed image obtained according to the first granularity processing, to obtain a raindrop-removed target image.

According to an aspect of the disclosure, there is provided an image processing apparatus including the following units. A raindrop processing unit is configured to perform a progressive removal processing of raindrops with different granularities on an image with raindrops, to obtain an image subjected to the removal processing of raindrops, herein the progressive removal processing of raindrops with different granularities includes at least: a first granularity processing and a second granularity processing. A fusion unit is configured to perform fusion processing on the image subjected to the removal processing of raindrops and a to-be-processed image obtained according to the first granularity processing, to obtain a raindrop-removed target image.

According to an aspect of the disclosure, there is provided an image processing apparatus including: a memory storing processor-executable instructions; and a processor configured to execute the stored processor-executable instructions to perform operations of: performing a progressive removal processing of raindrops with different granularities on an image with raindrops, to obtain an image subjected to the removal processing of raindrops, wherein the progressive removal processing of raindrops with different granularities comprises at least: a first granularity processing and a second granularity processing; and performing fusion processing on the image subjected to the removal processing of raindrops and a to-be-processed image obtained according to the first granularity processing, to obtain a raindrop-removed target image.

According to an aspect of the disclosure, there is provided an electronic device including: a processor; and a memory for storing instructions executable by the processor; herein the processor is configured to perform the image processing method.

According to an aspect of the disclosure, there is provided a computer readable storage medium having stored thereon computer program instructions that, when executed by a processor, cause the image processing method to be implemented.

According to an aspect of the disclosure, there is provided a computer program including computer readable codes that, when run in an electronic device, cause a processor in the electronic device to perform the image processing method.

It should be understood that both the foregoing general descriptions and the following detailed descriptions are exemplary and explanatory only, rather than being restrictive of the disclosure.

Other features and aspects of the disclosure will become apparent from the following detailed descriptions of exemplary embodiments with reference to the accompanying drawings.

### BRIEF DESCRIPTION OF THE DRAWINGS

The accompanying drawings, which are incorporated in the description and constitute a part of the description, illustrate embodiments consistent with the disclosure and is used to illustrate the technical solutions of the disclosure together with the description.

FIG. 1 illustrates a flowchart of an image processing method according to an embodiment of the disclosure.

FIG. 2 illustrates another flowchart of an image processing method according to an embodiment of the disclosure.

FIG. 3 illustrates yet another flowchart of an image processing method according to an embodiment of the disclosure.

FIG. 4 illustrates a schematic diagram of a residual dense block according to an embodiment of the disclosure.

FIG. 5 illustrates a block diagram of an image processing apparatus according to an embodiment of the disclosure.

FIG. 6 illustrates a block diagram of an electronic device according to an embodiment of the disclosure.

FIG. 7 illustrates a block diagram of an electronic device according to an embodiment of the disclosure.

### DETAILED DESCRIPTION

Various exemplary embodiments, features and aspects of the disclosure will be described in detail below with reference to the accompanying drawings. The same reference numerals in the drawings indicate elements with identical or similar functions. Although various aspects of the embodiments are shown in the drawings, the drawings are not necessarily drawn to scale, unless indicated specifically.

The special word “exemplary” as used herein means “serving as an example, embodiment or illustration”. Any embodiment described as “exemplary” herein is not necessarily to be construed as superior to or better than other embodiments.

The term “and/or” as used herein is merely an association that describes associated objects, and means that there may be three relationships, for example, A and/or B may mean that only A is present, both A and B are present, and only B is present. In addition, the term “at least one” as used herein means any one of multiple items or any combination of at least two of multiple items, for example, the inclusion of at least one of A, B or C may mean the inclusion of any one or more elements selected from the group composed of A, B and C.

In addition, numerous specific details are given in the following detailed description to better explain the disclosure. It should be appreciated by those skilled in the art that the disclosure may be practiced without certain specific details. In some instances, methods, means, elements and circuits well known to those skilled in the art have not been described in detail so as to highlight the spirit of the disclosure.

A high-quality automatic raindrop removal technology for an image with raindrops may be applied to many scenarios of daily life, such as removing the influence of raindrops on the line of sight in automatic driving to improve the driving quality; removing the interference of raindrops in smart portrait photography to obtain a more beautiful and clear background; performing a raindrop removal operation on images in the monitoring video, so that relatively clear monitoring images may still be obtained in the heavy rain weather, thereby improving the quality of the monitoring. By the automatic raindrop removal operation, high-quality scenario information may be obtained.

In the related methods for removing raindrops, raindrops are removed mainly based on pairwise rain/rain-free images, the usage of an end-to-end method of deep learning, in combination with technologies such as multi-scale modeling, a dense residual connection network, a video frame optical flow, etc. these methods simply pursue the raindrop removal effect, while neglects the protective modeling of the detailed information of the rain-free region in the image, and lacks some interpretability. The interpretability of data and machine learning model is one of the crucial aspects in the “usefulness” of data science, which ensures that the model is consistent with the problem to be solved, that is, not only the problem can be solved, but also one can know which link is used to solve the problem, rather than simply solving the problem without knowing which link plays a role in solving the problem.

In the related methods for removing raindrops, an end-to-end method for removing raindrops of an image based on single image is described as an example. The method uses multi-scale features based on pairwise single image data with/without rain to perform end-to-end modeling learning, including constructing a network including an encoder and a decoder using technologies such as a convolution neural network, a pooling operation, a de-convolution operation and an interpolation operation etc. The image with raindrops is input into the network, and the input image with raindrops is converted into the image without raindrops according to the supervision information of single rain-free image. However, according to the method, excessive rain removal easily occurs, and detailed information of a part of the image is lost, so that the image for which raindrops are removed has a problem of distortion.

In the related methods for removing raindrops, a method for removing raindrops based on a video stream is described as an example. The method captures video optical flows of raindrops between two frames by using information of timing sequences among video frames, and then removes dynamic raindrops by using the optical flows of the timing sequences, thereby obtaining an image without raindrops. However, on one hand, the applied scenario of the method is only applicable to a video data set, and is not applicable to a photographic scenario composed of single image; on the other hand, the method relies on information of two continuous frames, and when breakage of frames occurs, the rain removal effect is affected.

According to the above two methods, the explicit raindrop modeling and explanation of the rain removal task are not performed, while sufficient consideration and modeling of raindrops with different granularities lack, and therefore, it is difficult for them to master the balance problem between excessive rain removal and insufficient rain removal. The excessive rain removal means that the rain removal effect is too strong, and some image regions without raindrops are also erased; because the details of the image at the rain-free regions are lost, the problem of distortion of the image occurs. Insufficient rain removal means that the rain removal effect is too weak, and raindrops of the image are not sufficiently removed.

According to the disclosure, the details of the rain-free region of the image may be retained while raindrops are removed, based on the progressive removal processing of raindrops of an image from coarse to fine granularities. Since the raindrop feature information obtained by the first granularity processing stage is interpretable to a certain extent, the difference between raindrops and other non-raindrop information may be identified by the similarity comparison of the raindrop feature information at the second granularity processing stage, so that raindrops may be accurately removed and the details of the rain-free region of the image may be retained.

It should be noted that the first granularity processing refers to a coarse granularity raindrop removal processing; the second granularity processing refers to a fine granularity raindrop removal processing. The coarse granularity raindrop removal processing and the fine granularity raindrop removal processing are relative expressions, the purposes of both the coarse granularity raindrop removal processing and the fine granularity raindrop removal processing are to identify and remove raindrops from the image, but their removal degrees are different, and the coarse granularity raindrop removal processing is not accurate enough. Therefore, a more accurate processing effect may be obtained further by the fine granularity raindrop removal processing. For example, for drawing a sketch, coarse granularity is for contouring, and relatively, fine granularity is for drawing shadows and details.

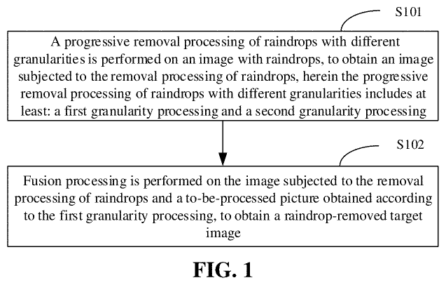

FIG. 1 illustrates a flowchart of an image processing method according to an embodiment of the disclosure, the method is applied to an image processing apparatus that may perform image classification, image detection, video processing etc. for example in a case where the processing apparatus is deployed to a terminal device or a server or is implemented by other processing devices. Herein, the terminal device may be a User Equipment (UE), a mobile device, a cellular telephone, a cordless telephone, a Personal Digital Assistant (PDA), a handheld device, a computing device, an in-vehicle device, a wearable device, etc. In some possible implementations, the processing method may be implemented by a processor invoking computer-readable instructions stored in a memory. As shown in FIG. 1, the flow includes the following operations.

In operation 101, a progressive removal processing of raindrops with different granularities is performed on an image with raindrops, to obtain an image subjected to the removal processing of raindrops, herein the progressive removal processing of raindrops with different granularities includes at least: a first granularity processing and a second granularity processing, i.e., processing at two stages.

In the first granularity processing stage, the image with raindrops is processed to obtain a to-be-processed image, and the to-be-processed image includes raindrop feature information for distinguishing raindrops from other non-raindrop information in the image. The raindrop feature information is obtained by learning through a large number of training samples at this stage, and raindrops are not completely removed at this stage. The to-be-processed image is used as an intermediate processing result obtained according to the first granularity processing; after the stage of the second granularity processing is entered, the raindrop similarity comparison may be performed according to the raindrop feature information, thereby obtaining the image subjected to the removal processing of raindrops. The result of the convolution processing of the to-be-processed image and the image subjected to the removal processing of raindrops may be fused to obtain a final raindrop-removed target image.

In a possible implementation, the first granularity processing is performed on the image with raindrops to obtain the to-be-processed image, herein the to-be-processed image includes raindrop feature information. The second granularity processing is performed on the to-be-processed image, and raindrop similarity comparison on the pixel points in the to-be-processed image is performed according to the raindrop feature information, to obtain the image subjected to the removal processing of raindrops. The image subjected to the removal processing of raindrops contains information of raindrop-free regions that is retained after the removal of raindrops. By the raindrop similarity comparison, raindrops in the image may be distinguished from other non-raindrop information (such as background information in the image, houses, cars, trees, pedestrians, etc.) without mistakenly removing the other non-raindrop information together when raindrops are removed.

In operation 102, fusion processing is performed on the image subjected to the removal processing of raindrops and the to-be-processed image, to obtain a raindrop-removed target image.

In an example, the fusion processing may be performed on the image subjected to the removal processing of raindrops and the result obtained by the convolution processing of the to-be-processed image to obtain the image with the removal of raindrops. For example, the to-be-processed image is input to a convolution block, and the convolution processing is performed to obtain an output result. The fusion processing is performed on the image subjected to the removal processing of raindrops and the output result to obtain the raindrop-removed target image.

For the fusion processing, the to-be-treated image (e.g., the image with the preliminary removal of rain) obtained at the first granularity processing stage may be subjected to a convolution operation (e.g., 3*3 convolution), then fused with the image subjected to the removal processing of raindrops (e.g., the approximately accurate image with the removal of rain obtained processed at two stages of the disclosure) obtained at the second granularity processing stage. The to-be-processed image is input into the convolution block, and the 3*3 convolution operation is performed. The sizes of the images input into the convolution block and output by the convolution block do not change, and the image features are processed. In the fusion process, the image features thereof and the image features obtained at the second granularity processing stage may be subjected to Concate, and then subjected to the convolution processing of 1*1 convolution kernel and the non-linear processing of the Sigmoid function to obtain the raindrop-removed target image (for example, the final image with the removal of rain). Concate is a connection function for connecting multiple image features, while the Sigmoid function is an activation function in a neural network, which is a non-linear function for introducing non-linearity, and the specific non-linear form is not limited.

According to the disclosure, for raindrops in the image, more detailed features, for example detailed information of images such as cars or pedestrians etc. in the background, may be retained by using the first granularity processing only; however, in terms of the processing granularity and the processing effect of raindrops, the first granularity processing is not careful compared with the second granularity processing, the second granularity processing is required to be further performed, and the image subjected to the removal processing of raindrops is obtained by using the second granularity processing; in terms of the removal processing of raindrops, the second granularity processing is superior to the first granularity processing, but it may result in loss of the detailed information, such as other non-raindrop information, of the image. Therefore, finally, it is also necessary to fuse the processing results obtained by the two granularity processing, that is, the to-be-processed image obtained by the first granularity processing is fused with the image subjected to the removal processing of raindrops obtained by the second granularity processing, so that the finally obtained target image may maintain a processing balance between the removal of raindrops to obtain a raindrop-free effect and the retention of other non-raindrop information, rather than a processing transition there-between.

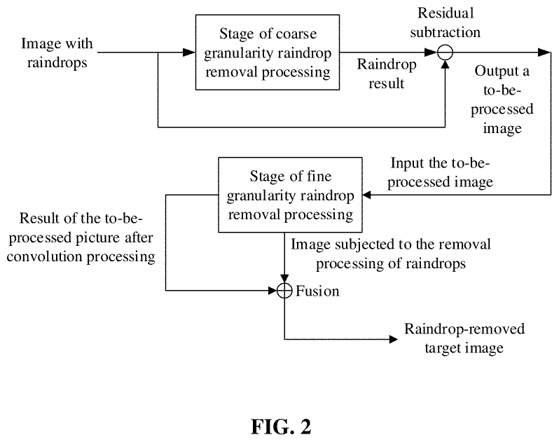

For the operations 101 and 102, an example is shown in FIG. 2. FIG. 2 illustrates a flowchart of an image processing method according to an embodiment of the disclosure, including processing at two raindrop removal stages, i.e., a coarse granularity processing and a fine granularity processing. The to-be-processed image may be an intermediate processing result obtained according to the first granularity processing. The image subjected to the removal processing of raindrops may be a processing result obtained according to the second granularity processing. Firstly, the image with raindrops is subjected to processing at the first granularity processing stage to obtain a raindrop result, such as a coarse texture rain-spot mask. Raindrops are not removed at the first granularity processing stage, and the raindrop feature information may be obtained by learning at the stage, for subsequent raindrop similarity comparison. The residual subtraction operation is performed between the image with raindrops and the raindrop result, to output the result of removing the coarse granularity raindrops, that is, the to-be-processed image for the next stage (the second granularity processing stage) processing. The to-be-processed image is subjected to processing at the second granularity processing stage to obtain the image subjected to the removal processing of raindrops. The result of the convolution processing of the to-be-processed image and the image subjected to the removal processing of raindrops are fused to obtain a final raindrop-removed target image. According to the disclosure, the target image obtained by the progressive removal processing of raindrops with different granularities via the image with raindrops, may retain the details of the rain-free region of the image while raindrops are removed.

In a possible implementation, the performing the first granularity processing on the image with raindrops to obtain the to-be-processed image, includes the following contents.

I. Residual dense processing and down-sampling processing are performed on the image with raindrops to obtain raindrop local feature information.

The image with raindrops is subjected to residual dense block of at least two layers and layer-by-layer down-sampling processing, to obtain a local feature map for characterizing the raindrop feature information. The local feature map is composed of local features for reflecting the local representation of the image features. There may be multiple local feature maps, for example, multiple local feature maps corresponding to the output of each layer may be obtained by the residual dense block at each layer and layer-by-layer down-sampling processing, and the residual fusion is performed on the multiple local feature maps and multiple global enhancement feature maps in a parallel manner to obtain the raindrop result. For another example, multiple local feature maps corresponding to the output of each layer may be obtained by the residual dense block of each layer and layer-by-layer down-sampling processing, the multiple local feature maps are connected in a serial manner, and the residual fusion is performed on the connected local feature maps and the multiple global enhancement feature maps to obtain the raindrop result.

In order to achieve a processing effect for removing raindrops in the image more accurately at the second granularity processing stage, it is therefore necessary to obtain, at the first granularity processing stage, local features in the image that are used to characterize the raindrop feature information, so as to apply the local features to the second granularity processing stage for raindrop similarity comparison, thereby distinguishing raindrops in the image from other non-raindrop information.

It should be noted that each layer has a residual dense block and a down-sampling block for performing dense residual and down-sampling processing, respectively. The local feature map is used as the raindrop local feature information.

In an example, the image with raindrops is input into an i-th layer residual dense block to obtain a first intermediate processing result; the first intermediate processing result is input into an i-th layer down-sampling block to obtain a local feature map. The local feature map processed by an (i+1)th layer residual dense block is input into an (i+1)th layer down-sampling block, and the raindrop local feature information is obtained through the down-sampling processing performed by the (i+1)th layer down-sampling block. The i is a positive integer equal to or greater than 1 and less than a preset value. The preset value may be 2, 3, 4 . . . m, etc. and m is an upper limit of the preset value, and may be configured according to the empirical value, or may be configured according to the accuracy of the desired raindrop local feature information.

In the layer-by-layer down-sampling processing, the local convolution kernel may be used for the convolution operation, and the local feature map may be obtained.

II. Region noise reduction processing and up-sampling processing are performed on the raindrop local feature information to obtain raindrop global feature information.

It should be noted that the region noise reduction processing may be processed by a region sensitive block. The region sensitive block may identify raindrops in the image. Other non-raindrop information irrelevant to raindrops, such as image background of trees, cars, pedestrians, etc. is used as noise, and the noise is distinguished from raindrops.

The local feature map is subjected to the region sensitive block of at least two layers and layer-by-layer up-sampling processing, to obtain a global enhancement feature map containing the raindrop feature information. The global enhancement feature map is defined relative to the local feature map, and the global enhancement feature map refers to a feature map that may represent image features over the entire image.

There may be multiple global enhancement feature maps, for example, multiple global enhancement feature maps corresponding to the output of each layer may be obtained by the region sensitive block of each layer and layer-by-layer up-sampling processing, and the residual fusion is performed on the multiple global enhancement feature maps and the multiple local feature maps in a parallel manner to obtain the raindrop result. For another example, multiple global enhancement feature maps corresponding to the output of each layer may be obtained by the region sensitive block of each layer and layer-by-layer up-sampling processing, the multiple global enhancement feature maps are connected in a serial manner, and the residual fusion is performed on the connected global enhancement feature maps and the multiple local feature maps to obtain the raindrop result.

It should be noted that each layer has a region sensitive block and an up-sampling block for performing region noise reduction and up-sampling processing, respectively. The global enhancement feature map is used as the raindrop global feature information, and the residual fusion is performed on the local feature map and the global enhancement feature map to obtain the raindrop result.

The local feature map is input to the global enhancement feature map obtained by the region sensitive block of each layer, and layer-by-layer up-sampling processing is performed respectively to obtain the amplified global enhancement feature map. The amplified global enhancement feature map and the local feature map obtained by residual dense processing at each layer are subjected to residual fusion on a layer-by-layer basis to obtain the raindrop result. The raindrop result may include a processing result obtained by performing residual fusion according to the raindrop local feature information and the raindrop global feature information.

In an example, the raindrop local feature information is input into an j-th layer region sensitive block to obtain a second intermediate processing result; the second intermediate processing result is input into an j-th layer up-sampling block to obtain a global enhancement feature map; and the global enhancement feature map processed by a (j+1)th layer region sensitive block is input into a (j+1)th layer up-sampling block, and the raindrop global feature information is obtained through the up-sampling processing performed by the (j+1)th layer up-sampling block; herein j is a positive integer equal to or greater than 1 and less than a preset value. The preset value may be 2, 3, 4 . . . n, etc. and n is an upper limit of the preset value, and may be configured according to the empirical value, or may be configured according to the accuracy of the desired raindrop global feature information.

In the layer-by-layer up-sampling processing, the convolution operation in the related art may be used, that is, the local convolution kernel may be used for the convolution operation.

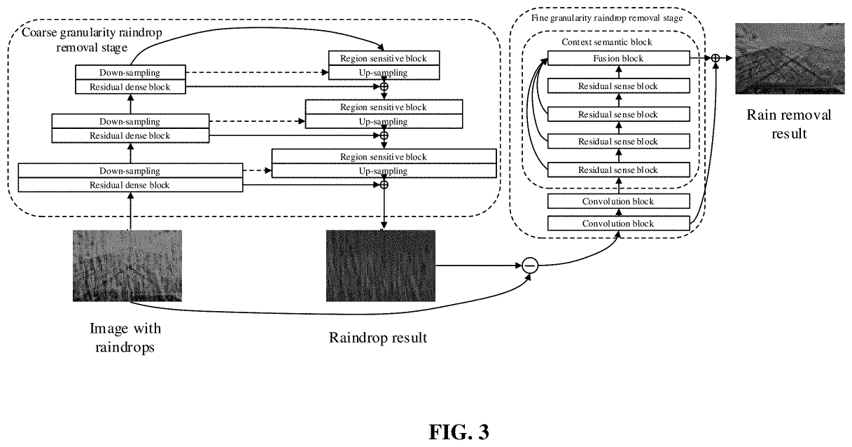

For up-sampling and down-sampling, as shown in FIG. 3, the connection between the up-sampling block and the down-sampling block refers to a skip connection between the up-sampling and down-sampling. Specifically, the down-sampling may be performed firstly, then the up-sampling is performed, and the skip connection is performed for the up-sampling and down-sampling processing of the same layer. In the down-sampling process, the spatial coordinate information of each down-sampling feature point needs to be recorded, and when connected to the up-sampling correspondingly, the spatial coordinate information needs to be utilized, and the spatial coordinate information is used as a part of the up-sampling input, to better implement the spatial recovery function of the up-sampling. Spatial recovery means that since the sampling (including the up-sampling and the down-sampling) of the image results in distortion, in short, it may be understood that the down-sampling is down-scaling the image and the up-sampling is up-scaling the image, then, since down-scaling the image by the down-sampling results in a change in position, when restoration without distortion is required, the position thereof may be recovered by the up-sampling.

III. Residual subtraction is performed between a raindrop result obtained according to the raindrop local feature information and the raindrop global feature information and the image with raindrops, to obtain the to-be-processed image.

The raindrop result is a processing result obtained according to the local feature information for characterizing the raindrop features in the image and the global feature information for characterizing all the features in the image, and may also be referred to as a preliminary raindrop removal result obtained through the first granularity processing stage. Then, residual subtraction (subtraction between any two features) is performed between the image with raindrops input to the neural network of the disclosure and the raindrop result to obtain the to-be-processed image.

In a possible implementation, the performing the second granularity processing on the to-be-processed image, and performing the raindrop similarity comparison on the pixel points in the to-be-processed image according to the raindrop feature information, to obtain the image subjected to the removal processing of raindrops includes the following operations. The to-be-processed image may be input into the convolution block for convolution processing, and then input into a context semantic block to obtain context semantic information containing deep semantic features and shallow spatial features. Herein, the deep semantic features may be used to identify, for example, the difference between rain and information of other categories (cars, trees, humans) and make classification. The shallow spatial features may be used to obtain a specific part of the category in the identified category, and the specific part of the category may be obtained according to the specific texture information. For example, in a scenario in which a human body is scanned, a human face, a human hand, a trunk etc. may be identified by the deep semantic features, and for the human hand, a position of a palm of the human hand may be positioned by the shallow spatial features. For the disclosure, the rain region may be identified by the deep semantic features, and then the positions of the raindrops may be positioned by the shallow spatial features.

In an example, classification is performed according to the context semantic information to identify a rain region in the to-be-processed image, herein the rain region contains raindrops and other non-raindrop information. Since raindrops are present in the rain region, it is necessary to further remove raindrops, and it is necessary to distinguish the raindrop region from the raindrop-free region, thus it is necessary to perform, according to the raindrop feature information, raindrop similarity comparison on the pixel points in the rain region, and position, according to a result of the comparison, raindrop regions where the raindrops are located and the raindrop-free regions. Raindrops in the raindrop regions are removed and the information of the raindrop-free regions is retained to obtain the image subjected to the removal processing of raindrops.

In a possible implementation, the inputting the to-be-processed image, after being subjected to convolution processing, into the context semantic block to obtain the context semantic information containing deep semantic features and shallow spatial features, includes the following operations. The to-be-processed image is input into a convolution block for convolution processing, to obtain a high-dimensional feature vector for generating the deep semantic features. The high-dimensional feature vector refers to a feature with a relatively large number of channels, such as a feature with 3000*wide*high. The high-dimensional feature vector does not include spatial information. For example, the high-dimensional feature vector may be obtained by performing semantic analysis on a sentence. For example, a two-dimensional space is a two-dimensional vector, a three-dimensional space is a three-dimensional vector, and more than three-dimension, such as four-dimension, five-dimension, belongs to the high-dimensional feature vector. The high-dimensional feature vector is input into the context semantic block for multi-layer residual dense processing, to obtain the deep semantic features. Fusion processing is performed on the deep semantic features obtained by the residual dense processing at each layer and the shallow spatial features, to obtain the context semantic information. It should be noted that the context semantic information refers to information that combines the deep semantic features and the shallow spatial features.

It should be noted that the deep semantic features are mainly used for classification and identification, the shallow spatial features are mainly used for specific positioning, and the deep semantic features and the shallow spatial features are defined relatively. For the stage of processing by the multi-layer convolution block as shown in FIG. 3, the shallow spatial features are obtained at the initial convolution processing, and the deep semantic features are obtained by performing the convolution processing many times later. It may also be said that in the convolution process, the first half obtains the shallow spatial features, while the second half obtains the deep semantic features relative to the first half. For the semantic representation, the deep semantic features are more abundant than the shallow spatial features. This is determined by the convolution features of the convolution kernel. An image has an increasingly smaller effective space after the multi-layer convolution processing, thus some spatial information is lost by the deep semantic features. However, since the multi-layer convolution learning is performed, a semantic feature expression that is more abundant than the shallow spatial features may be obtained.

The context semantic block includes a residual dense block and a fusion block, which perform the residual dense processing and fusion processing respectively. In an example, the obtained high-dimensional feature vector is input to the context semantic block, and the deep semantic features are obtained firstly by the multi-layer residual dense block, and then the deep semantic features output by the multi-layer dense residual error block are concatenated together by the fusion block. The fusion processing may be performed by a 1*1 convolution operation, so that the context semantic information output by the multi-layer context semantic block is fused together, thereby fully fusing the deep semantic features and the shallow spatial features, and the detailed information of the image may also be enhanced while assisting in further removing some residual fine granularity raindrops.

### Application Examples

FIG. 3 illustrates yet another flowchart of an image processing method according to an embodiment of the disclosure. As shown in FIG. 3, a progressive processing method of a coarse granularity raindrop removal stage with a fine granularity raindrop removal stage may be combined, to remove raindrops in the image and perform a process of learning rain removal progressively. Herein in the coarse granularity raindrop removal stage, the local features and the global features may be fused by the region sensitive block to mine the feature information of the coarse granularity raindrops; in the fine granularity raindrop removal phase, the fine granularity raindrops may be removed by the context semantic block while the detailed information of the image is protected from damage. As shown in FIG. 3, the image processing method according to the embodiment of the disclosure includes the following two stages.

I. Coarse Granularity Raindrop Removal Stage

At this stage, the image with raindrops may be input, and then a coarse granularity raindrop image is generated, and the residual subtraction is performed between the image with raindrops and the generated raindrop image to achieve the purpose of removing the coarse granularity raindrops. This stage mainly includes a residual dense block, an up-sampling operation, a down-sampling operation and a region sensitive block, and as shown in FIG. 3, this stage is mainly divided into the following four steps.

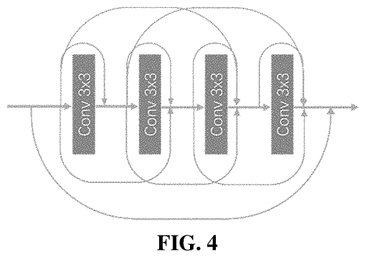

1) The input image with raindrops firstly passes the residual dense blocks and is subjected to the down-sampling operations to obtain the deep semantic features, herein the down-sampling operations may obtain feature information of different spatial scales and enrich the receptive fields of the feature. The down-sampling operation is a convolution operation based on the local convolution kernel, and the local feature information may be learned. The schematic diagram of the residual dense block is shown in FIG. 4, and may be composed of multiple 3*3 convolutional blocks.

As described herein with reference to FIG. 4, for the processing of the residual dense block, the three-layer residual dense block is composed of three residual blocks, and the input and output of each residual block are concatenated together to be used as the input of the next residual block. For the processing of the down-sampling block, the down-sampling is performed using maxpool, which is an implementation of a pooling operation that may be performed after the convolution processing. The maxpool may be a processing for pixel points of each channel in multiple channels (e.g., R/G/B in the image are three channels) to obtain a feature value for each pixel point, and the maxpool selects the maximum feature value in a fixed sliding window (e.g., sliding window 2*2) as a representation.

2) The region sensitive block is constructed according to the following equation (1), where yᵢ^{r} and xᵢ^{r} denote the i-th position information of the corresponding output feature map and the i-th position information of the input feature map in the r-th region, respectively, and correspondingly, xⱼ^{r} denote the j-th position information of the input feature map in the r-th region. C ( ) denotes a normalization operation, for example Σ_{∀j}f(xᵢ, xⱼ). Both F ( ) and g ( ) refer to convolution neural networks, of which the processing may be a convolution operation corresponding to 1*1.

In the construction of the region sensitive block, the value of each output pixel in a specified region of the image is obtained by weighted summation of the value of each input pixel, and the corresponding weight is obtained by performing an internal product operation between any two of the input pixels. By the region sensitive block, a relationship expression between each pixel in the image and other pixels may be obtained, so that global enhancement feature information may be obtained. For the task of removing raindrops, it is possible to assist in identifying the features of raindrops and non-raindrop more effectively by the global enhancement feature information, and by construction of the region sensitive block based on the specified area, it is also possible to reduce the calculation amount more effectively and improving the efficiency.

$${y}_{i}^{r} = \frac{1}{C ( {x}^{r} )} {\sum }_{j ∈ r} f ( {x}_{i}^{r} , {x}_{j}^{r} ) g ( {x}_{j}^{r} ) \qquad ( 1 )$$

3) The local feature information obtained in 1) is input into the region sensitive block, and the global enhancement feature information may be obtained by the region sensitive block, and amplified by the up-sampling, then the layer-by-layer residual fusion is performed between the amplified global feature map (a feature map composed by the global enhancement feature information) and the shallow local feature map (a feature map composed by the local feature information), and finally a coarse granularity raindrop result is output. By obtaining the raindrop result obtained at this stage of the disclosure, the neural network architecture of the disclosure is made more interpretable relative to an end-to-end network, while through a two-stage rain removal process, not only some coarse granularity raindrops may be removed, but also the image details of the rain-free region may be effectively retained to prevent excessive rain removal. With the raindrop result, it also provides reference indication to train the neural network of the disclosure so as to understand and adjust the learning of the neural network of the disclosure timely to achieve a better training effect.

Here, descriptions will be made in combination with FIG. 4, the block of FIG. 4 corresponds to the overall neural network architecture of FIG. 3, that is, the residual dense block. Firstly, the image may pass the residual dense block and then is subjected to the down-sampling, such operation repeats three times to obtain three features with different resolutions, i.e. the final down-sampling feature, respectively. Then, the down-sampling feature firstly passes the region sensitive block to obtain the raindrop feature, and then the up-sampling is performed to recover the same size as the feature before the third down-sampling, and then the residual fusion is performed (the residual fusion is to add any two of the features directly), and then it passes a layer of the region sensitive block and up-sampling, and the residual fusion is performed on it and the feature before the second down-sampling, and so on. After obtaining the feature of the third residual fusion, the raindrop result obtained at the first granularity processing stage is obtained, that is, the preliminary raindrop result, and then the residual subtraction is performed, and the residual subtraction is to subtract the obtained raindrop result from the input image with raindrops, to obtain the to-be-processed image that is, the to-be-processed preliminary rain removal result. Finally, after the to-be-processed image is input into the second stage for fine rain removal, the final raindrop-removed target image is obtained.

4) The coarse granularity raindrop result is obtained from 3), and the residual subtraction is performed between the input image with raindrops and the raindrop result to obtain a result of removing the coarse granularity raindrops, that is, a preliminary rain removal result of removing the rain at the coarse granularity stage.

II. Fine Granularity Raindrop Removal Stage

This stage consists in removing the residual fine granularity raindrops while retaining the detailed features of the rain-free region of the image, and this stage contains a common convolution operation and a context semantic block. The context semantic block includes a series of residual dense blocks and a fusion block. As shown in FIG. 3, the algorithm at this stage is mainly divided into the following three steps.

1) The preliminary rain removal result of the coarse granularity raindrop removal stage are used as an input to this stage, and high-dimensional features are obtained using the convolution block, such as two cascaded convolution layers.

2) The obtained high-dimensional features are input to the context semantic block, and the deep semantic features are obtained firstly by the multi-layer residual dense block, the schematic diagram of the residual dense block is shown in FIG. 4, and may be composed of multiple 3*3 convolutional blocks. Then, the outputs of the residual dense blocks at multiple layers are concatenated together by the fusion block. The fusion processing on the context semantic information of the multi-layer residual dense block may be performed by a 1*1 convolution operation, to fully fuse the deep semantic features and the shallow spatial features, and the detailed information of the image may be enhanced while further removing some residual fine granularity raindrops, to obtain a detail enhancement result at this stage.

3) Finally, the preliminary rain removal result of the first stage and the detail enhancement result of this stage are fused to obtain final rain removal result.

For the fusion processing, simply speaking, the processing results of the above two steps are subjected to Concate, and then subjected to the 1*1 convolution operation and the non-linear processing of the Sigmoid function to complete the fusion. Specifically, the to-be-treated image (e.g., the image with the preliminary removal of rain) obtained at the first granularity processing stage may be subjected to a convolution operation (e.g., 3*3 convolution), then fused with the image subjected to the removal processing of raindrops (e.g., the approximately accurate image with the removal of rain obtained processed at two stages of the disclosure) obtained at the second granularity processing stage. The to-be-processed image is input into the convolution block, and the 3*3 convolution operation is performed. The sizes of the images input into the convolution block and output by the convolution block do not change, and the image features are processed. In the fusion process, the image features thereof and the image features obtained at the second granularity processing stage may be subjected to Concate, and then subjected to the convolution processing of 1*1 convolution kernel and the non-linear processing of the Sigmoid function to obtain the raindrop-removed target image (for example, the final image with the removal of rain). Concate is a connection function for connecting multiple image features, while the Sigmoid function is an activation function in a neural network, which is a non-linear function for introducing non-linearity, and the specific non-linear form is not limited.

According to the disclosure, the first granularity processing at first stage of “local-global” may be performed by using the local features extracted by the local convolution kernel in combination with the global features extracted by the region sensitive block, and then the second granularity processing at second stage is performed by using the context semantic block, so that the detailed information of the image may also be retained while the fine granularity raindrops are removed. Since the raindrop feature information may be learned, it may divide the end-to-end “black box” process in the related art into an interpretable two-stage rain removal process, so that the task performance of the scenario related to the raindrop removal operation is improved. For example, the disclosure is used to remove the influence of raindrops on the line of sight in automatic driving to improve the driving quality; remove the interference of raindrops in smart portrait photography to obtain a more beautiful and clear background; perform a raindrop removal operation on images in the monitoring video, so that relatively clear monitoring images may still be obtained in the heavy rain weather.

It should be appreciated by those skilled in the art that in the above methods of the detailed description, the order in which the steps are written does not mean a strict execution order for forming any limitation on the implementation, and the specific execution order of the steps should be determined in terms of their functions and possible intrinsic logics.

The above method embodiments mentioned in the disclosure may be combined with each other to form a combined embodiment without departing from the principle logic, and will not be repeated in the disclosure.

In addition, the disclosure also provides an image processing apparatus, an electronic device, a computer-readable storage medium, and a program, which may be used to implement any one of the methods for processing images provided in the disclosure. The corresponding technical solutions and descriptions may refer to corresponding recordation of the section of the method, and will not be repeated here.

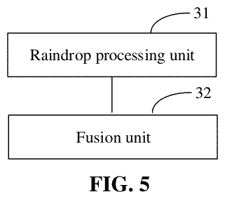

FIG. 5 illustrates a block diagram of an image processing apparatus according to an embodiment of the disclosure. As shown in FIG. 5, the processing apparatus includes the following units. A raindrop processing unit 31 is configured to perform a progressive removal processing of raindrops with different granularities on an image with raindrops, to obtain an image subjected to the removal processing of raindrops, herein the progressive removal processing of raindrops with different granularities includes at least: a first granularity processing and a second granularity processing. A fusion unit 32 is configured to perform fusion processing on the image subjected to the removal processing of raindrops and a to-be-processed image obtained according to the first granularity processing, to obtain a raindrop-removed target image.

In a possible implementation, the raindrop processing unit is configured to: perform the first granularity processing on the image with raindrops to obtain the to-be-processed image, herein the to-be-processed image includes raindrop feature information; and perform the second granularity processing on the to-be-processed image, and perform, according to the raindrop feature information, raindrop similarity comparison on the pixel points in the to-be-processed image, to obtain the image subjected to the removal processing of raindrops, herein the image subjected to the removal processing of raindrops contains information of raindrop-free regions that is retained after the removal of raindrops.

In a possible implementation, the raindrop processing unit is configured to: perform residual dense processing and down-sampling processing on the image with raindrops to obtain raindrop local feature information; perform region noise reduction processing and up-sampling processing on the raindrop local feature information to obtain raindrop global feature information; and perform residual subtraction between a raindrop result obtained according to the raindrop local feature information and the raindrop global feature information and the image with raindrops, to obtain the to-be-processed image.

In a possible implementation, the raindrop result includes a processing result obtained by performing residual fusion according to the raindrop local feature information and the raindrop global feature information.

In a possible implementation, the raindrop processing unit is configured to: input the image with raindrops into an i-th layer residual dense block to obtain a first intermediate processing result; input the first intermediate processing result into an i-th layer down-sampling block to obtain a local feature map; and input the local feature map processed by an (i+1)th layer residual dense block into an (i+1)th layer down-sampling block, and obtain the raindrop local feature information through the down-sampling processing performed by the (i+1)th layer down-sampling block; herein i is a positive integer equal to or greater than 1 and less than a preset value. The preset value may be 2, 3, 4 . . . m, etc. and m is an upper limit of the preset value, and may be configured according to the empirical value, or may be configured according to the accuracy of the desired raindrop local feature information.

In a possible implementation, the raindrop processing unit is configured to: input the raindrop local feature information into an j-th layer region sensitive block to obtain a second intermediate processing result; input the second intermediate processing result into an j-th layer up-sampling block to obtain a global enhancement feature map; and input the global enhancement feature map processed by a (j+1)th layer region sensitive block into a (j+1)th layer up-sampling block, and obtain the raindrop global feature information through the up-sampling processing performed by the (j+1)th layer up-sampling block; herein j is a positive integer equal to or greater than 1 and less than a preset value. The preset value may be 2, 3, 4 . . . n, etc. and n is an upper limit of the preset value, and may be configured according to the empirical value, or may be configured according to the accuracy of the desired raindrop global feature information.

In a possible implementation, the raindrop processing unit is configured to: perform a convolution operation using a local convolution kernel in the i-th layer down-sampling block to obtain the raindrop local feature information.

In a possible implementation, the raindrop processing unit is configured to: input the to-be-processed image into a context semantic block to obtain context semantic information containing deep semantic features and shallow spatial features; perform classification according to the context semantic information to identify a rain region in the to-be-processed image, herein the rain region contains raindrops and other non-raindrop information; perform, according to the raindrop feature information, raindrop similarity comparison on the pixel points in the rain region, and position, according to a result of the comparison, raindrop regions where the raindrops are located and raindrop-free regions; and remove the raindrops in the raindrop regions and retain the information of the raindrop-free regions to obtain the image subjected to the removal processing of raindrops.

In a possible implementation, the raindrop processing unit is configured to: input the to-be-processed image into a convolution block for convolution processing, to obtain a high-dimensional feature vector for generating the deep semantic features; input the high-dimensional feature vector into the context semantic block for multi-layer residual dense processing, to obtain the deep semantic features; and perform fusion processing on the deep semantic features obtained by the residual dense processing at each layer and the shallow spatial features, to obtain the context semantic information.

In a possible implementation, the fusion unit is configured to: input the to-be-processed image into a convolution block for convolution processing, to obtain an output result; and perform fusion processing on the image subjected to the removal processing of raindrops and the output result to obtain the raindrop-removed target image.

In some embodiments, the apparatus provided by the embodiments of the disclosure may have functions or include blocks for performing the methods described in the above method embodiments, and specific implementations thereof may refer to the descriptions of the above method embodiments, and are not repeated herein for brevity.

The embodiments of the disclosure also provide a computer readable storage medium having stored thereon computer program instructions, herein the computer program instructions, when being executed by a processor, implement the above method. The computer readable storage medium may be a volatile computer readable storage medium or a non-volatile computer readable storage medium.

The embodiments of the disclosure provide a computer program product including computer readable codes, when the computer readable codes are run in a device, a processor in the device performs instructions to implement the image processing method as provided in any one of the above embodiments.

The embodiments of the disclosure also provide another computer program product for storing computer readable instructions that, when executed, allows a computer to perform operations of the image processing method as provided in any one of the above embodiments.

The computer program product may be embodied specifically in hardware, software or a combination thereof. In an alternative embodiment, the computer program product is embodied specifically as a computer storage medium, and in another alternative embodiment, the computer program product is embodied specifically as a software product, such as a Software Development Kit (SDK) etc.

The embodiments of the disclosure also provide an electronic device including a processor; a memory for storing instructions executable by the processor; herein the processor is configured to perform the above method.

The electronic device may be provided as a terminal, a server or other forms of devices.

In the embodiments of the disclosure, a progressive removal processing of raindrops with different granularities is performed on an image with raindrops, to obtain an image subjected to the removal processing of raindrops, herein the progressive removal processing of raindrops with different granularities includes at least: a first granularity processing and a second granularity processing; fusion processing is performed on the image subjected to the removal processing of raindrops and a to-be-processed image obtained according to the first granularity processing, to obtain a raindrop-removed target image. Since the embodiments of the disclosure use the progressive removal processing at two stages, i.e., the first granularity processing stage and the second granularity processing stage, respectively, not only raindrops may be removed, but also excessive processing will not occur to remove other non-raindrop information together, thereby maintaining a good balance between the removal of raindrops and the retention of raindrop-free region information.

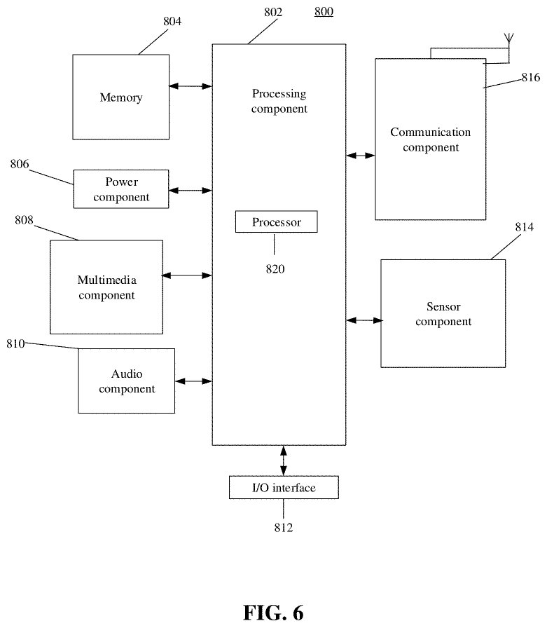

FIG. 6 is a block diagram of an electronic device 800 according to an exemplary embodiment. For example, the electronic device 800 may be a terminal such as a mobile phone, a computer, a digital broadcast terminal, a messaging device, a game console, a tablet device, a medical device, an exercise device, a personal digital assistant, etc.

Referring to FIG. 6, the electronic device 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or a part of the steps in the above methods. Moreover, the processing component 802 may include one or more modules which facilitate the interaction between the processing component 802 and other components. For example, the processing component 802 may include a multimedia block to facilitate the interaction between the multimedia component 808 and the processing component 802.

The memory 804 is configured to store various types of data to support the operation of the electronic device 800. Examples of such data include instructions for any applications or methods operated on the electronic device 800, contact data, phonebook data, messages, images, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the electronic device 800. The power component 806 may include a power management system, one or more power sources, and other components associated with the generation, management, and distribution of power in the electronic device 800.

The multimedia component 808 includes a screen providing an output interface between the electronic device 800 and the user. In some embodiments, the screen may include a liquid crystal display (LCD) and a touch panel (TP). When the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the electronic device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the electronic device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, which may be a keyboard, a click wheel, buttons, and the like. The buttons may include, but are not limited to, a home button, a volume button, a starting button, and a locking button.

The sensor component 814 includes one or more sensors to provide status assessments of various aspects of the electronic device 800. For instance, the sensor component 814 may detect an open/closed status of the electronic device 800, relative positioning of components, e.g., the display and the keypad, of the electronic device 800; the sensor component 814 may also detect a change in position of the electronic device 800 or a component of the electronic device 800, a presence or absence of user contact with the electronic device 800, an orientation or an acceleration/deceleration of the electronic device 800, and a change in temperature of the electronic device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the electronic device 800 and other devices. The electronic device 800 can access a wireless network based on a communication standard, such as Wi-Fi, 2G, or 3G, or a combination thereof. In an exemplary embodiment, the communication component 816 receives a broadcast signal or broadcast associated information from an external broadcast management system via a broadcast channel In an exemplary embodiment, the communication component 816 also includes a near field communication (NFC) block to facilitate short-range communications. For example, the NFC block may be implemented based on a radio frequency identification (RFID) technology, an infrared data association (IrDA) technology, an ultra-wideband (UWB) technology, a Bluetooth (BT) technology, and other technologies.

In exemplary embodiments, the electronic device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above methods.

In exemplary embodiments, there is also provided a non-transitory computer readable storage medium, such as the memory 804 including computer program instructions, executable by the processor 820 in the electronic device 800, for performing the above methods.

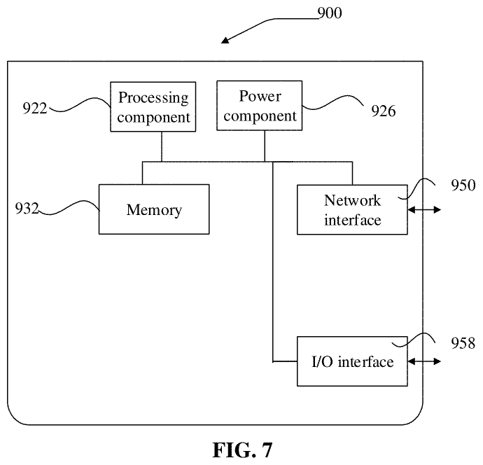

FIG. 7 is a block diagram of an electronic device 900 according to an exemplary embodiment. For example, the electronic device 900 may be provided as a server. With reference to FIG. 7, the electronic device 900 includes a processing component 922 which further includes one or more processors, and memory resources represented by a memory 932, for storing instructions, such as applications, that may be executed by the processing component 922. The applications stored in the memory 932 may include one or more blocks each of which corresponding to a set of instructions. In addition, the processing component 922 is configured to execute instructions to perform the above methods.

The electronic device 900 may also include a power component 926 configured to perform power management of the electronic device 900, a wired or wireless network interface 950 configured to connect the electronic device 900 to a network, and an input/output (I/O) interface 958. The electronic device 900 may operate based on an operating system, such as Windows Server™, Mac OS X™, Unix™, Linux™, FreeBSD™ or the like, stored in the memory 932.

In an exemplary embodiment, there is also provided a computer readable storage medium, which may be a volatile storage medium or a non-volatile storage medium, such as the memory 932 including computer program instructions which are executable by the processing component 922 of the electronic device 900 to perform the above methods.

The disclosure may be a system, method, and/or computer program product. The computer program product may include a computer readable storage medium having computer readable program instructions thereon for allowing a processor to implement various aspects of the disclosure.

The computer readable storage medium may be a tangible device that may hold and store instructions used by the instruction execution device. The computer readable storage medium may be, for example, but not limited to, an electrical storage device, a magnetic storage device, an optical storage device, an electromagnetic storage device, a semiconductor storage device, or any suitable combination of the above devices. More specific examples (non-exhaustive lists) of the computer readable storage medium include: a portable computer disk, a hard disk, a random access memory (RAM), a read only memory (ROM), an erasable programmable read only memory (EPROM or flash memory), a static random access memory (SRAM), a portable compact disk read only memory (CD-ROM), a digital versatile disk (DVD), a memory stick, a floppy disk, a mechanical encoding device, e.g., a punch card or in-groove bump structure on which instructions are stored, and any suitable combination of the above memories. The computer readable storage medium as used herein is not construed as an instantaneous signal itself, such as a radio wave or other freely propagating electromagnetic wave, an electromagnetic wave propagating through a waveguide or other transmission medium (e.g., an optical pulse through a fiber optic cable), or an electrical signal transmitted through a wire.

The computer readable program instructions described herein may be downloaded from a computer readable storage medium to various computing/processing devices, or downloaded via a network, such as the Internet, a local area network (LAN), a wide area network and/or a wireless network, to an external computer or external storage device. The network may include copper transmission cables, fiber optic transmission, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium in the respective computing/processing device.

The computer program instructions for performing the operations of the disclosure may be assembly instructions, instruction set architecture (ISA) instructions, machine instructions, machine-related instructions, microcode, firmware instructions, state setting data, or source or object codes written in any combination of one or more programming languages, including object-oriented programming languages such as Smalltalk, C++, and the like, and conventional procedural programming languages such as “C” language or similar programming languages. The computer readable program instructions may be executed entirely on the user computer, executed partly on the user computer, executed as a separate software package, executed partly on the user computer and partly on the remote computer, or entirely on the remote computer or server. In the case of the remote computer involved, the remote computer may be connected to the user computer through any kind of networks, including a local area network (LAN) or a wide area network (WAN), or may be connected to an external computer (e.g., connected through the Internet using an Internet service provider). In some embodiments, the electronic circuit may execute the computer readable program instructions by personalizing electronic circuits, such as programmable logic circuits, field programmable gate arrays (FPGAs) or programmable logic arrays (PLAs), with the status information of the computer readable program instructions, so as to implement various aspects of the disclosure.

Various aspects of the disclosure are described herein with reference to flowcharts and/or block diagrams of methods, apparatus (systems) and computer program products according to the embodiments of the disclosure. It should be understood that each block of the flowcharts and/or block diagrams, and combination of blocks of the flowcharts and/or block diagrams, may be implemented by computer readable program instructions.

These computer readable program instructions may be provided to a processor of a general purpose computer, a special purpose computer, or other programmable data processing apparatuses to produce a machine such that when being executed by the processor of the computer or other programmable data processing apparatuses, the instructions produce an apparatus for implementing the functions/acts specified in one or more blocks of the flowchart and/or block diagram. The computer readable program instructions may also be stored in a computer readable storage medium, these instructions allow a computer, a programmable data processing apparatus, and/or other devices to operate in a particular manner, such that the computer readable medium having instructions stored thereon includes an article of manufacture that includes instructions that implement various aspects of the functions/acts specified in one or more blocks of the flowchart and/or block diagram.

Computer readable program instructions may also be loaded onto a computer, other programmable data processing apparatuses, or other devices, such that a series of operational steps are performed on the computer, other programmable data processing apparatuses, or other devices to produce a computer-implemented process, thus the instructions that are executed on the computer, other programmable data processing apparatuses, or other devices implement the functions/actions specified in one or more blocks of the flowcharts and/or block diagrams.

The flowcharts and block diagrams in the drawings illustrate architectures, functions, and operations of possible implementations of the system, method, and computer program product according to the embodiments of the disclosure. In this regard, each block of the flowchart or block diagram may represent a block, a program segment, or part of an instruction that contains one or more executable instructions for implementing a specified logical function. In some alternative implementations, the functions noted in the blocks may also occur in an order different from that noted in the drawings. For example, two successive blocks may actually be executed in parallel substantially, and sometimes they may be executed in a reverse order, depending on the functions involved. It should also be noted that each block of the block diagram and/or flowchart, and combination of blocks of the block diagram and/or flowchart, may be implemented with a dedicated hardware-based system that performs the specified functions or actions, or may be implemented with a combination of the dedicated hardware and computer instructions.

The embodiments of the disclosure may be combined with each other without departing from the logic, the descriptions of the embodiments are focused on different aspects, and for the portion described in focus, reference may be made to the descriptions of other embodiments.

The embodiments of the disclosure are described as above, the above descriptions are illustrative, rather than exhaustive, and are not limited to the embodiments as disclosed. Many modifications and variations will be apparent to those of ordinary skill in the art without departing from the scopes and spirits of the illustrated embodiments. The choice of terms as used herein is intended to best explain the principles of the embodiments, practical applications, or technical improvements to the available technologies, or to enable other of ordinary skill in the art to understand the embodiments as disclosed herein.

What is claimed is:

1. An image processing method, comprising:
performing a progressive removal processing of raindrops with different granularities on an image with raindrops, to obtain an image subjected to the removal processing of raindrops, wherein the progressive removal processing of raindrops with different granularities comprises at least: a first granularity processing and a second granularity processing; and
performing fusion processing on the image subjected to the removal processing of raindrops and a to-be-processed image obtained according to the first granularity processing, to obtain a raindrop-removed target image.

2. The method of claim 1, wherein performing the progressive removal processing of raindrops with different granularities on the image with raindrops to obtain the image subjected to the removal processing of raindrops comprises:
performing the first granularity processing on the image with raindrops to obtain the to-be-processed image, wherein the to-be-processed image includes raindrop feature information; and
performing the second granularity processing on the to-be-processed image, and performing, according to the raindrop feature information, raindrop similarity comparison on pixel points in the to-be-processed image, to obtain the image subjected to the removal processing of raindrops, wherein the image subjected to the removal processing of raindrops contains information of raindrop-free regions that is retained after the removal of raindrops.

3. The method of claim 2, wherein performing the first granularity processing on the image with raindrops to obtain the to-be-processed image comprises:
performing residual dense processing and down-sampling processing on the image with raindrops to obtain raindrop local feature information;
performing region noise reduction processing and up-sampling processing on the raindrop local feature information to obtain raindrop global feature information; and
performing residual subtraction between a raindrop result obtained according to the raindrop local feature information and the raindrop global feature information and the image with raindrops, to obtain the to-be-processed image.

4. The method of claim 3, wherein the raindrop result comprises a processing result obtained by performing residual fusion according to the raindrop local feature information and the raindrop global feature information.

5. The method of claim 3, wherein performing the residual dense processing and down-sampling processing on the image with raindrops to obtain the raindrop local feature information comprises:
inputting the image with raindrops into an i-th layer residual dense block to obtain a first intermediate processing result;
inputting the first intermediate processing result into an i-th layer down-sampling block to obtain a local feature map; and
inputting the local feature map processed by an (i+1)th layer residual dense block into an (i+1)th layer down-sampling block, and obtaining the raindrop local feature information through the down-sampling processing performed by the (i+1)th layer down-sampling block, wherein i is a positive integer equal to or greater than 1 and less than a preset value.

6. The method of claim 3, wherein performing the region noise reduction processing and up-sampling processing on the raindrop local feature information to obtain the raindrop global feature information comprises:
inputting the raindrop local feature information into an j-th layer region sensitive block to obtain a second intermediate processing result;
inputting the second intermediate processing result into an j-th layer up-sampling block to obtain a global enhancement feature map; and
inputting the global enhancement feature map processed by a (j+1)th layer region sensitive block into a (j+1)th layer up-sampling block, and obtaining the raindrop global feature information through the up-sampling processing performed by the (j+1)th layer up-sampling block,
wherein j is a positive integer equal to or greater than 1 and less than a preset value.

7. The method of claim 5, wherein obtaining the raindrop local feature information through the down-sampling processing performed by the (i+1)th layer down-sampling block comprises: performing a convolution operation using a local convolution kernel in the (i+1)th layer down-sampling block to obtain the raindrop local feature information.

8. The method of claim 2, wherein performing the second granularity processing on the to-be-processed image and performing, according to the raindrop feature information, the raindrop similarity comparison on the pixel points in the to-be-processed image to obtain the image subjected to the removal processing of raindrops comprises:
inputting the to-be-processed image into a context semantic block to obtain context semantic information containing deep semantic features and shallow spatial features;
performing classification according to the context semantic information to identify a rain region in the to-be-processed image, wherein the rain region contains raindrops and other non-raindrop information;
performing, according to the raindrop feature information, the raindrop similarity comparison on the pixel points in the rain region, and positioning, according to a result of the comparison, raindrop regions where the raindrops are located and the raindrop-free regions; and
removing the raindrops in the raindrop regions and retaining the information of the raindrop-free regions to obtain the image subjected to the removal processing of raindrops.

9. The method of claim 8, wherein the inputting the to-be-processed image into the context semantic block to obtain the context semantic information containing deep semantic features and shallow spatial features comprises:
inputting the to-be-processed image into a convolution block for convolution processing, to obtain a high-dimensional feature vector for generating the deep semantic features;
inputting the high-dimensional feature vector into the context semantic block for multi-layer residual dense processing, to obtain the deep semantic features; and
performing fusion processing on the deep semantic features obtained by the multi-layer residual dense processing at each layer and the shallow spatial features, to obtain the context semantic information.

10. The method of claim 1, wherein performing the fusion processing on the image subjected to the removal processing of raindrops and the to-be-processed image obtained according to the first granularity processing, to obtain the raindrop-removed target image comprises:
inputting the to-be-processed image into a convolution block for convolution processing, to obtain an output result; and
performing fusion processing on the image subjected to the removal processing of raindrops and the output result to obtain the raindrop-removed target image.

11. An image processing apparatus, comprising:
a memory storing processor-executable instructions; and
a processor configured to execute the stored processor-executable instructions to perform operations of:
performing a progressive removal processing of raindrops with different granularities on an image with raindrops, to obtain an image subjected to the removal processing of raindrops, wherein the progressive removal processing of raindrops with different granularities comprises at least: a first granularity processing and a second granularity processing; and
performing fusion processing on the image subjected to the removal processing of raindrops and a to-be-processed image obtained according to the first granularity processing, to obtain a raindrop-removed target image.

12. The apparatus of claim 11, wherein performing the progressive removal processing of raindrops with different granularities on the image with raindrops to obtain the image subjected to the removal processing of raindrops comprises:
performing the first granularity processing on the image with raindrops to obtain the to-be-processed image, wherein the to-be-processed image includes raindrop feature information; and
performing the second granularity processing on the to-be-processed image, and performing, according to the raindrop feature information, raindrop similarity comparison on pixel points in the to-be-processed image, to obtain the image subjected to the removal processing of raindrops, wherein the image subjected to the removal processing of raindrops contains information of raindrop-free regions that is retained after the removal of raindrops.

13. The apparatus of claim 12, wherein performing the first granularity processing on the image with raindrops to obtain the to-be-processed image comprises:
performing residual dense processing and down-sampling processing on the image with raindrops to obtain raindrop local feature information;
performing region noise reduction processing and up-sampling processing on the raindrop local feature information to obtain raindrop global feature information; and
performing residual subtraction between a raindrop result obtained according to the raindrop local feature information and the raindrop global feature information and the image with raindrops, to obtain the to-be-processed image.

14. The apparatus of claim 13, wherein the raindrop result comprises a processing result obtained by performing residual fusion according to the raindrop local feature information and the raindrop global feature information.

15. The apparatus of claim 13, wherein performing the residual dense processing and down-sampling processing on the image with raindrops to obtain the raindrop local feature information comprises:
inputting the image with raindrops into an i-th layer residual dense block to obtain a first intermediate processing result;
inputting the first intermediate processing result into an i-th layer down-sampling block to obtain a local feature map; and
inputting the local feature map processed by an (i+1)th layer residual dense block into an (i+1)th layer down-sampling block, and obtaining the raindrop local feature information through the down-sampling processing performed by the (i+1)th layer down-sampling block, wherein i is a positive integer equal to or greater than 1 and less than a preset value.

16. The apparatus of claim 13, wherein performing the region noise reduction processing and up-sampling processing on the raindrop local feature information to obtain the raindrop global feature information comprises:
inputting the raindrop local feature information into an j-th layer region sensitive block to obtain a second intermediate processing result;
inputting the second intermediate processing result into an j-th layer up-sampling block to obtain a global enhancement feature map; and
inputting the global enhancement feature map processed by a (j+1)th layer region sensitive block into a (j+1)th layer up-sampling block, and obtaining the raindrop global feature information through the up-sampling processing performed by the (j+1)th layer up-sampling block,
wherein j is a positive integer equal to or greater than 1 and less than a preset value.

17. The apparatus of claim 15, wherein obtaining the raindrop local feature information through the down-sampling processing performed by the (i+1)th layer down-sampling block comprises: performing a convolution operation using a local convolution kernel in the (i+1)th layer down-sampling block to obtain the raindrop local feature information.

18. The apparatus of claim 12, wherein performing the second granularity processing on the to-be-processed image and performing, according to the raindrop feature information, the raindrop similarity comparison on the pixel points in the to-be-processed image to obtain the image subjected to the removal processing of raindrops comprises:
inputting the to-be-processed image into a context semantic block to obtain context semantic information containing deep semantic features and shallow spatial features;
performing classification according to the context semantic information to identify a rain region in the to-be-processed image, wherein the rain region contains raindrops and other non-raindrop information;
performing, according to the raindrop feature information, raindrop similarity comparison on the pixel points in the rain region, and positioning, according to a result of the comparison, raindrop regions where the raindrops are located and the raindrop-free regions; and
removing the raindrops in the raindrop regions and retain the information of the raindrop-free regions to obtain the image subjected to the removal processing of raindrops.

19. The apparatus of claim 18, wherein the inputting the to-be-processed image into the context semantic block to obtain the context semantic information containing deep semantic features and shallow spatial features comprises:
inputting the to-be-processed image into a convolution block for convolution processing, to obtain a high-dimensional feature vector for generating the deep semantic features;
inputting the high-dimensional feature vector into the context semantic block for multi-layer residual dense processing, to obtain the deep semantic features; and
performing fusion processing on the deep semantic features obtained by the multi-layer residual dense processing at each layer and the shallow spatial features, to obtain the context semantic information.

20. A non-transitory computer readable storage medium having stored thereon computer program instructions that, when executed by a processor, cause the processor to perform operations of:
performing a progressive removal processing of raindrops with different granularities on an image with raindrops, to obtain an image subjected to the removal processing of raindrops, wherein the progressive removal processing of raindrops with different granularities comprises at least: a first granularity processing and a second granularity processing; and
performing fusion processing on the image subjected to the removal processing of raindrops and a to-be-processed image obtained according to the first granularity processing, to obtain a raindrop-removed target image.
